(19) United States
(12) Patent Application Publication
(10) Pub. No.: US 2014/0298265 A1
(43) Pub. Date: Oct. 2, 2014

(54) PHOTO-REVIEW CREATION

(71) Applicant: Triptease Limited, London (GB)

(72) Inventor: Charlie Osmond, London (GB)

(21) Appl. No.: 14/197,139

(22) Filed: Mar. 4, 2014

Related U.S. Application Data
(60) Provisional application No. 61/772,524, filed on Mar. 4, 2013.

(51) Int. Cl. G06F 3/0484; G06F 3/0482

(52) U.S. Cl. CPC G06F 3/04845; G06F 3/0482
USPC 715/835

(57) ABSTRACT

Photo-reviews provide an aesthetically pleasing and rich review experience resulting in greater comprehension and understanding of a reviewable item. In addition to providing a richer review format that is aesthetically pleasing, photo-reviews may be associated with a ranking provided by a user. Users that give particular items a particular ranking may be recommended to view reviews by users that rank items in a similar manner. Reviews that are ranked the same may be compared with one another, such that no two review have the same ranking.

### CROSS REFERENCE TO RELATED APPLICATIONS

This application claims the benefit of U.S. provisional application 61/772,524 filed on Mar. 4, 2013 and the contents thereof are expressly incorporated by reference herein it its entirety.

### TECHNICAL FIELD

The present technology pertains to photo-reviews, and more specifically pertains to creating and posting a photo review.

### BACKGROUND

The field of providing reviews changed dramatically with the advent of the Internet. Reviewing users can now quickly create and publicly post reviews regarding just about any product, service, business, location, etc. For example, a reviewing user can generate and post a review to one of a number of review websites freely available on the Internet. Some reviews on the Internet include images related to the review. Unfortunately, review websites often do not allow users to edit an image, or focus on a point of interest within an image, when creating a review. Rather, some reviews merely allow a user to associate an image with a review. Often even good reviews look terrible, and the reviewed hotel, restaurant, etc. would be appalled at how their establishment is being represented. Similarly, even the reviews creator will not be motivated to share the review if it looks too unpleasant. In both instances the purpose of the review is thwarted.

Further, on many review websites, a review of a particular item may contain both positive and negative reviews. In some cases, different people may have different expectations of a particular item. For instance, people unaccustomed to staying in upscale hotels may rank any nice hotel very highly. Meanwhile, someone that regularly stays in upscale hotels may rank the same hotel much lower.

Moreover, many review websites have a limited number of rankings that a user may provide. For example, some review websites may only allow a user to provide a ranking between 1 and 5 stars. In such a case, if a person wanted to view how a particular user ranked New York compared to San Francisco as vacation destinations, and the review website indicated that the particular user ranked both New York and San Francisco with 5 stars, the person would not know which location the particular user liked better. Accordingly, there is a need for an improved review format.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for creating and ranking photo-reviews. Photo-reviews, including at least visual display of the reviewed content (e.g., a photo or video), provide an aesthetically pleasing and rich review experience. Photo-reviews generally place more emphasis on a photo and/or image than regular review websites. As described herein, an emphasis is placed on placing photos in photo reviews within a template. Further, users placing photos within a review template are able to edit photos prior to finalizing their review. For example, a user focus a photo on a particular point of interest by cropping an image to be placed in a template. Similarly, images may be positioned in such a way that only focal points of the image are shown when an image is placed in a template.

In some embodiments described herein, an inquiring user can view images along with rankings provided by a reviewer, resulting in greater comprehension and understanding of the reviewable item. A review management system can identify users eligible to create a review for one or more reviewable items, such as hotels, restaurants, services, locations, purchasable items, etc., and prompt the identified users to create a photo-review. For example, identified users can be presented with a photo-review creation interface enabling a user to create a photo-review.

In addition to providing rankings, some review systems can categorize reviews by the type of user that made them. For example, previous reviews made by a user may cause that user to be placed in a particular category of user. Some users may be categorized as jet-setters, while other users may be categorized as budget-conscious-users. This way, a searching user knows more about the type of user that made a review. In some cases, a user is only presented with reviews made by a particular type of user.

Further, some review systems prevent users from giving multiple reviews the same ranking. For example, some review systems may require that a user to indicate whether they would rank New York higher than San Francisco, or vice versa. As another example, a review system may allow a user to rank a newly created review in comparison with previous reviews the user has created.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example electronic environment in which methods and systems discussed herein can be executed, in accordance with various embodiments;

FIG. 2 illustrates an exemplary embodiment of a photo-review interface that allows a user to create a photo-review;

FIG. 3 illustrates an exemplary embodiment of a photo-review interface that allows a user to create a photo-review;

FIG. 4 illustrates an exemplary embodiment of a photo-review interface that allows a user to rank a photo-review;

FIG. 5 illustrates an exemplary embodiment of a photo-review interface that allows a user to rank a photo-review;

FIG. 6 illustrates an exemplary embodiment of a photo-review interface that allows a user to view photo-reviews;

FIG. 7 illustrates an exemplary method of creating a photo review;

FIG. 8 illustrates an exemplary method of creating a photo review; and

FIGS. 9A-9B illustrate exemplary electronic environments, in accordance with various embodiments.

### DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

The disclosed technology addresses the need in the art for creating and ranking photo-reviews. Photo-reviews, including at least a visual display of the reviewed content (e.g., a photo or video), provide an aesthetically pleasing and rich review experience. An inquiring user can view images along with the rankings provided by a reviewer, resulting in greater comprehension and understanding of the reviewable item. In addition to providing a richer review format, sorted photo-reviews can provide for a pleasing and user-relevant review. For example, photo-reviews may be categorized by type of user making the review.

In some embodiments reviewers can be categorized according to various attributes. For example, users having 5-star preferences in hotels can be categorized differently than users having 3 or 4-star preferences. The system can periodically analyze a user's reviews and determine an appropriate categorization for the user based on the type of hotels they most commonly stay at. Such categorization can be adjusted if a user always ranks properties in a particular star classification too high or low for a standard user having the same taste. As such they can be some normalization of rankings by reviewers within a particular category of user.

In some embodiments, a user's categorization can be used to weight rankings of reviews they provide. For example a user ranking a hotel that fits their preference profile will be unchanged, while if the user rates a hotel that is below their preference profile (2-stars while their profile is for 3-star properties) can be weighted higher since they would be expected to review the hotel more harshly because it is below their typical standards. Likewise, if the same user with 3-star preference rates a 4-star hotel, their review might be weighted downward since they would be expected to like to hotel because it exceeds their typical standards.

A review management system can allow users to create a review for one or more reviewable items, such as hotels, restaurants, services, locations, items, etc. and prompt the identified users to create a photo-review. For example, users can be presented with a photo-review creation interface enabling a user to create a photo-review.

In some embodiments, the created photo-review can be posted to a review website that maintains reviews for a number of different reviewable items. Further, in some embodiments, the review management system can determine if the reviewing user has one or more social networking accounts and, if so, prompt the reviewing user to post the photo review to one of their social networking accounts. For example, the reviewing user's e-mail address can be used to determine if the reviewing user has a social networking account with one or more social networking websites.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software.

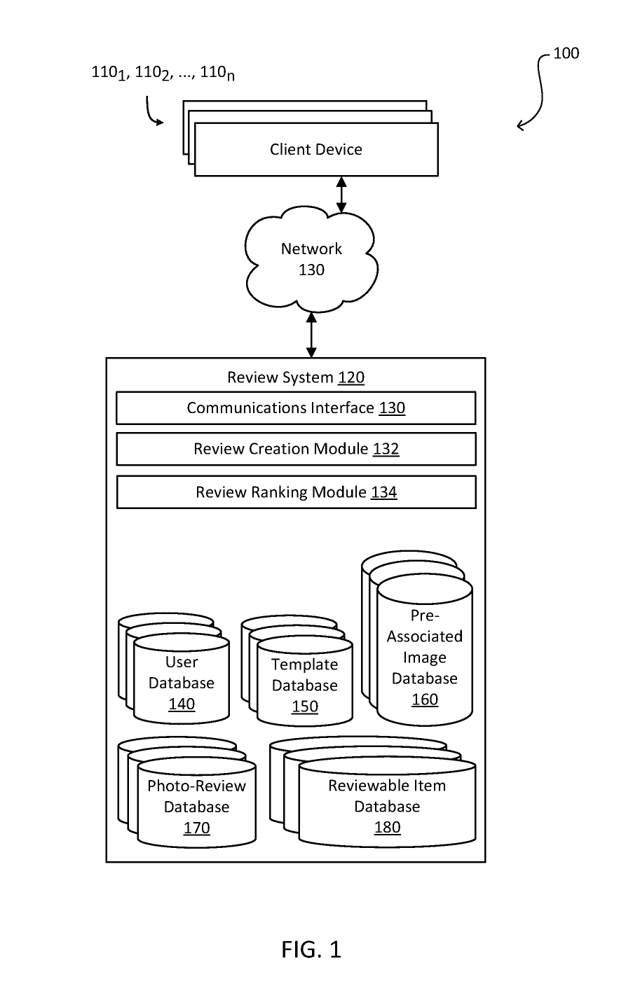

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, content can be delivered to client devices 110₁, 110₂, . . . , 110ₙ (collectively “110”) connected to network 130 by direct and/or indirect communications with review management system 120. Client devices 110 can be any network enabled computing device, such as desktop computers; mobile computers; wearable computers; handheld communications devices, e.g. mobile phones, smart phones, tablets; smart televisions; set-top boxes; and/or any other network enabled computing devices. Furthermore, review management system 120 can concurrently accept connections from and interact with multiple client devices 110.

Review management system 120 can be one or more servers and can receive a request for electronic content, such as a web page, an application, a media item, etc., from one of client devices 110. Thereafter, review management system 120 can assemble a content package and transmit the assembled content page to the requesting one of client devices 110. An assembled content package can include a photo review including at least a visual display of the reviewed content (e.g., a photo or video) and a ranking. Assembled content can also include text, additional graphics or video, audio, executable code, or any combination thereof. To facilitate communications with the client devices 110 and/or any other device or component, review management system 120 can include communications interface 130.

Review management system 120 can comprise or be coupled with one or more databases (or other data storage devices) including user profile database 140 that contains user profiles or other information about users, template database 150 that contains templates to assist with the creation of photo-reviews, pre-associated image database 160 which can include pre-associated images of reviewable items, photo-review database 170 which can contain photo-reviews created by users or administrators, and reviewable item database 180 which can contain items that can be reviewed.

Reviewable items can include any item, service, business, etc., that can be reviewed. For example, reviewable items can include, but are not limited to: geographic locations such as countries or regions, lodging such as a hotel or hostel, transportation such as an airline or cruise ship, restaurants, landmarks, restaurants, entertainment, businesses, purchasable items, etc.

Review management system 120 can include photo-review creation module 132 that can be configured to interact with various databases to create photo-reviews. For example, photo-review creation module 132 can interact with some or all of the databases shown in FIG. 1 (i.e., user profile database 140, template database 150, pre-associated image database 160, photo-review database 170, and reviewable item database 180).

To create photo-reviews, photo-review creation module 132 can be configured to identify potential reviewing users and prompt the identified potential reviewing users to create a photo-review. For example, in some embodiments, user profiles stored in user profile database 140 can include data regarding activities of the users in relation to reviewable items in reviewable item database 180. Activities can include any sort of action performed by a user, such as purchases made, vacations taken by the user, reservations made by the user, etc. Photo-review creation module 132 can communicate with user profile database 140 to access the user profiles and identify users that have recorded activity with a reviewable item in reviewable item database 180. For example, photo-review creation module 132 can identify user profiles including data that a user stayed at a hotel included in reviewable item database 180. In some embodiments, the photo-review request can prompt a potential reviewing user to create a photo-review for a specified reviewable item. Alternatively, the photo-review request can prompt a potential reviewing user to create a photo-review for multiple reviewable items. For example, the photo-review request can prompt a user to create a photo-review for each reviewable item for which user activity was detected. In some embodiments, the photo-review request can include interactive elements, such as buttons, links, etc., that, when selected, initiate the photo-review creation process for the specified reviewable item.

In some embodiments, photo-review creation module 132 can be configured to present the reviewing user with a photo-review creation interface that provides the users with the tools, data, etc., to create a photo-review. For example the photo review creation module can provide a template that requires a selection of a photo or other visual representation of the reviewed item along with a rating. A template can also provide locations for titles, commentary, social media links, etc.

Photo-review creation module 132 can be configured to select one or more available templates to provide the reviewing user. In some embodiments, photo-review creation module 132 can select templates based on the reviewable item. For example, the templates can be selected based on the type of reviewable item, such as a whether the reviewable item is a purchasable item, restaurant, location, hotel, airline, etc. Templates stored in template database 150 can include metadata identifying a type of reviewable item the template is best suited for and photo-review creation module 132 can use the metadata to select the templates best suited for the type of the reviewable item to be reviewed.

A template can include one or more configurable areas enabling a user to create a photo-review. For example, a template can include configurable areas designed to present photographs, text, headings, audio, video, etc. A user can use the photo-review interface to select one of the provided templates and interact with the configurable areas of the template to create the photo-review. For example, the photo-review interface can enable a user to enter text, images, etc. into the configurable areas. Configurable areas of templates that enable a user to enter images are also referred to as photo-regions.

In some embodiments, photo-review creation module 132 can select a subset of the pre-associated images based on a review focus associated with a photo-region of the template. For example, a template can include multiple photo-regions that each have a designated review focus. For instance, a template for a photo-review of a hotel can include a photo-region designated to the rooms and another photo-region designated to the pool.

Photo-review creation module 132 can gather metadata from the template and the pre-associated images to determine the size, proportions, etc., of the pre-associated images, template and configurable areas, and then select a subset of the pre-associated images accordingly. For example, in some embodiments, photo-review creation module 132 can select a subset of the pre-associated images that have a total area within a predetermined variance of the area of a template and/or photo-region. Alternatively, in some embodiments, photo-review creation module 132 can select a subset of the pre-associated images that have proportions, i.e. height and length, within a predetermined variance of the template and/or photo-region.

In some embodiments, photo-review creation module 132 can be configured to automatically crop images selected by a user to include in a photo-review. Thus, an image selected by a user can automatically be included by a user without further input from the user. For example, in some embodiments, photo-review creation module 132 can crop the image to fit the proportions of the template or photo-region of the template. The cropped image can then be reduced or expanded to fit the photo-region.

In some embodiments, photo-review module 132 can crop images based on a determined focal point of the image. For example, a pre-associated image can include a focal point which can be used as a center to crop the image. In some embodiments, images can be cropped, rotated, skewed, and/or resized such that the focal point remains centered. In some embodiments, the image can include metadata that identifies the focal point. Alternatively, in some embodiments, an image can be analyzed to determine the focal point. For example, a person's pupils in the image can be determined to be the focal point of the image. As another example, the largest captured object in the image can be determined to be the focal point of the image. In some embodiments, a user can select the focal point of the image. In some embodiments a template is configured to provide an interface for manipulating the placement of the image within a portion of a template reserved for the image.

In some embodiments, a user selects a photo-region in order to place an image inside the photo-region. In some embodiments, the image must have the same proportions as the photo-region. Thus, if a user uploads an image that does not have the same proportions as the photo-region, the review creation module 132 can crop the image such that it has the same proportions as the photo-region. Similarly, if a user chooses an image from a gallery of images and that image does not have the same proportions as the photo-region, the review creation module 132 can crop the image from the gallery such that it has the same proportions as the photo-region. In other embodiments, a selected image does not need to have the same proportions as the photo-region. For example, a user may select a photo-region designed to show a square image, where the length of the image is the same as its height. If a user selects an image that is not square, the user may place the image in the photo-region regardless. In some embodiments, the user may drag and manipulate the image such that only a portion of the image is showing (e.g., the template may mask portions of the image).

It should be noted that in some embodiments, a template may be manipulated to change the size of photo-review regions. For example, a user may change a square region to a region with a 4:6 ratio. As another example, a template may transform to the size or the proportions of a selected image.

Photo-reviews created by a user can be posted and made publicly available by review system 120. For example, photo-reviews can be posted to a review website hosted by review system 120, where they can be searched and accessed by inquiring users.

Review management system 120 can also include photo-review ranking module 134 that can be configured to associate a ranking with a photo-review. A ranking may represent a number, such as an integer between one and ten. As addressed above, a ranking may be expressed as a group of symbols, such as stars. The photo-review ranking module 134 may be coupled with any of the databases 140, 150, 160, 170, 180. For example, the photo-review ranking module may associate a user-rating with a user in the user database 140. As another example, a photo-review ranking module 134 may create categories to differentiate between reviewable items in the reviewable item database 180.

As addressed above, some ranking systems may not provide users with correct and/or relevant rankings. For example, a ranking system may only allow a user to associate 1, 2, 3, 4, or 5 stars with a reviewable item. The photo-review ranking module 134 is configured to address these problems and provide users with a better review. In embodiments discussed herein, users may provide a first type of ranking, such as stars, and a second, comparative ranking intended to prevent reviews that have the same first type of ranking from being ranked equally.

In some embodiments, each review a user must enter one number for the first type of ranking, and one number for the comparative ranking. If the first type of ranking is the same as another review previously created by the user, the user must choose a comparative ranking that is not the same as the previously created review. For example, if a user ranks three vacation destinations with the same number of stars, the user must provide different comparative rankings for those three vacation destinations.

In some embodiments, rankings may be displayed and/or manipulated along a widget including a line. For example, a user may click and drag an image or arrow representing the review up or down along a line, where at least one other image representing a review is shown along the line. Different sections of the line can represent different numerical values associated with a review.

In some embodiments, reviews are sorted in a list by their rankings. The rankings may be changed by dragging one review higher or lower on the list of reviews. For example, while two reviews might both have a three star rating, the system may require a relative preference to be indicated for any review in the same category having a three star rating. In some embodiments, a user cannot drag a review with a lower first type of ranking (e.g., three stars) above a review with a higher first type of ranking (e.g., five stars). In some embodiments, a second user is able to modify the list belonging to a first user.

Thus, the photo-review ranking module 134 can be configured to prevent a user from having two reviews with the same ranking. It should be understood, however, that in some embodiments the photo-review ranking module 134 may allow a user to have two reviews with the same ranking if the reviewable items are sufficiently different. For example, the photo-review ranking module 134 may allow a user to create a review for a bakery with a five star ranking, as well as a review for a hotel with a five star ranking.

Further, the photo-review ranking module 134 can provide better reviews to users by categorizing different types of users. In some embodiments users can be categorized users based on a quality metric, such as star ratings. The review system 120 can analyze a user's reviews and determine a preference for a quality criterion. For example, the review system 120, can determine that given user predominately stays at 4-star hotels, and categorize the user as having a 4-star preference.

In some embodiments, users can be characterized by profile attributes. For example a user can be categorized as a business traveler if the user has a number of reviews categorized as part of a business trip. In another example, the user can be categorized as a frequent beach traveler if a significant number of hotels the user has stayed in are in beach locations.

In some embodiments users can be characterized by behavior attributes. For example, the review system 120 can analyze user provided reviews and determine that given reviewer is value conscious or price sensitive. A user can be considered value conscious if their reviews are determined to be more favorable when the price paid to stay at the hotel was a discounted price. If the occurrence of such favorable reviews is statistically significant the reviewer might be value conscious and indicate that perceived value is a significant factor in influencing ratings.

In some embodiments the review system 120 can classify users according to preference specific factors that contribute to a user's rating decisions. For example, photo-review ranking module 134 may determine that a user's ranking is correlated to whether a hotel provides warm towels.

In some embodiments, user classifications can be used to weight or adjust review rankings to normalize ranking to make them more applicable to a broader set of users. For example a user with 5-star hotel taste will likely poorly review a 2-star hotel. Such a reviewer should not negatively affect a user with 2-star taste because the user with 5-star standards is not similar to a user with 2-star standards. Therefore, the a review of a 2-star hotel by a user with 5-star standards could be weighted higher to be more relevant to the overall population.

In some embodiments, adjustments to user reviews can be made dynamically according to the user browsing reviews. In such instances the user review by the user with 5-star taste of a 2-star property can be left as is when reviewed by a fellow user with 5-star taste, but be weighted higher when reviewed by users with 2, 3, or 4 star taste. The amount of the weighting could be dynamic and variable depending on the taste of the given user. For example, in the example given above, the property would receive a bigger adjustment when shown to a user of 2-star standards, and smaller when shown to a user with 4-star standards since users with 4-star standards are more similar to a user with 5-star standards and therefore less adjustment is needed for the review to be meaningful. In some embodiments users can only see reviews made from reviewers with similar standards. For example a user with 3-star taste would only see reviews from users with 2, 3, or 4-star standards because these are the reviews that are most generally relevant to them.

In some embodiments, user's reviews may be subject to an adjustment factor that takes into account the user's rating. For example, two users may each have a review of the same item with the same ranking. The user having a higher personal rating may have their otherwise same review be weighted higher than the user with the lower rating because the user with a higher ranking is assumed to be a more critical user or have higher standards. In some embodiments, only lists created by users of the same type may be combined. In some embodiments, rankings are averaged or aggregated. Also, rankings may be weighted based on various factors, such as the rating of a user, and then be combined into a list. Rankings may be weighted based on the time at which a user created the review. In some embodiments, a user is prompted to rank a review with respect to other reviews from a specified period of time. For example, a user may be prompted to compare the ranking of one review with the rankings of other reviews from the last five years. As another example, an ordered list of reviews may be adjusted based on the popularity of the reviewable items. Popularity may be measured by the amount of activity associated with a reviewable item on a social network. Popularity may also be associated with the amount of searches specifying the reviewable items performed on various search engines.

While review management system 120 is presented with specific components, it should be understood by one skilled in the art, that the architectural configuration of review management system 120 is simply one possible configuration and that other configurations with more or less components are also possible.

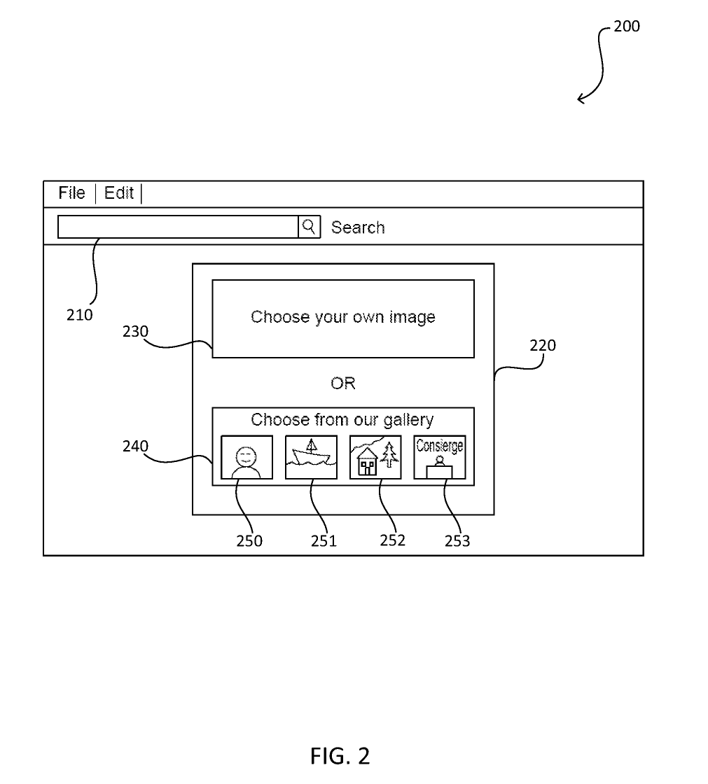

FIG. 2 illustrates an exemplary embodiment of photo-review interface 200 configured to allow a user to create a photo-review. As shown, photo-review interface 200 includes a graphical user interface (GUI) 220 with buttons that allow a user to choose an image to upload 230 or to choose from a gallery of images 240 that are pre-associated with reviewable items. As shown, a user may select from images 250, 251, 252 and 253. Of course in various embodiments, if a user clicks on a button to choose from a gallery of images 240 the photo review system 120 may send a user to another webpage to select an image. Also, photo-review interface 200 includes a search bar 210 that allows users to search photo-reviews. Search bar 210 may allow users to search by locations, images, colors, landmarks, travel companies, etc.

In some embodiments, the GUI 220 may appear after a user selects a template. For example, a user clicking on a photo-region within a template may cause the GUI 220 to appear. In some embodiments, the images that in the gallery may be proportional to a photo-region. If the image is not proportional, in some embodiments the review creation module 132 may indicate that the image must be cropped. In other embodiments, the image may be placed in the photo-region such that only a portion of the image is displayed in the review.

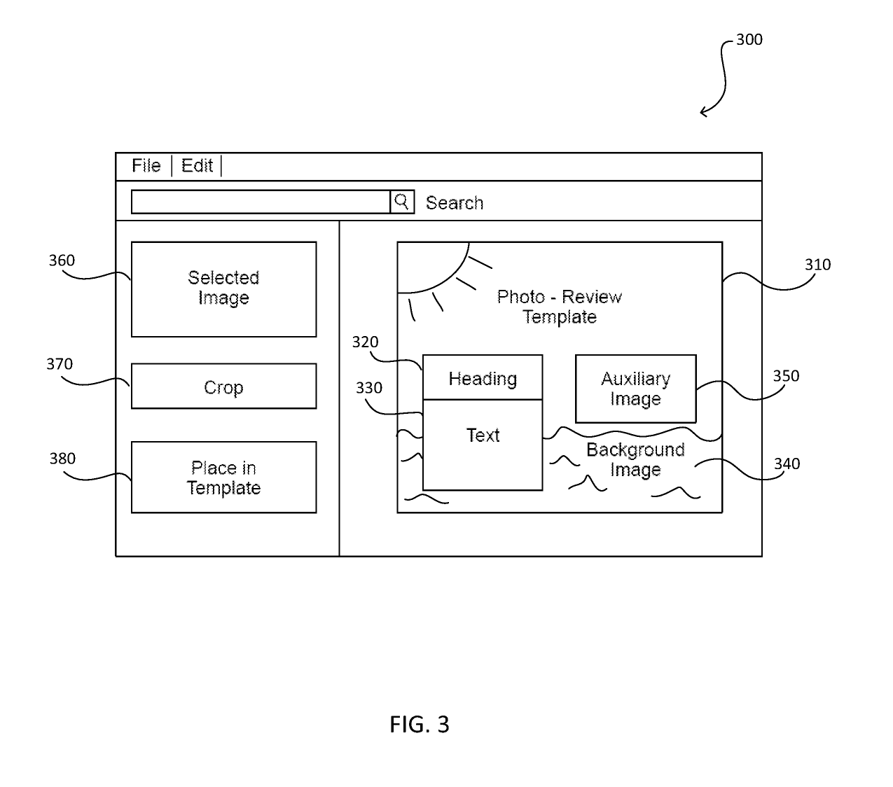

FIG. 3 illustrates exemplary embodiment of a photo-review interface 300. As shown, review creation module 132 may display a preview of how the review will appear when finished. In some embodiments, a photo-review template 310 may be displayed within photo-review interface 300. As described above, a photo-review template may comprise at least one photo-review region 340, 350 and a configurable area for text 330 and/or a heading 360. The photo-review template ensures that the finished review will be ascetically pleasing, and worth sharing. In some embodiments, photo-review regions comprise the background 340 of a review (also referred to as a background image 340). For example, background image 340 is an image of an ocean with a sun above it. Some photo-regions may be smaller such as the auxiliary image photo-region 350 shown.

A selected image 360 to be placed in a template may be proportional to a photo-region, or disproportional. In some embodiments a selected image may not be placed into a photo-region if it is not proportional to the photo-region. In some embodiments, a crop widget 370 is available to allow a user to crop an image. In addition, widgets configured to resize an image are may also be available. In some embodiments, a user can use a widget allowing the user to place the selected image in the template 380.

In some embodiments, a photo-review can be rendered and/or stored as an image file (e.g., a bitmap (.bmp), a graphics interchange format image (.gif), etc.) or as portable document file (.pdf). In some embodiments, a photo-review can be displayed on a review website. As an example, all of the photo-reviews created by a user can be shown on a page associated with that user. In some embodiments, a photo-review can be stored as a portable image or document such that the photo-review can be emailed, sent to a social network, texted, shared, etc. In some embodiments a page and/or application used to create photo-reviews can include a button or widget to email or otherwise share the review.

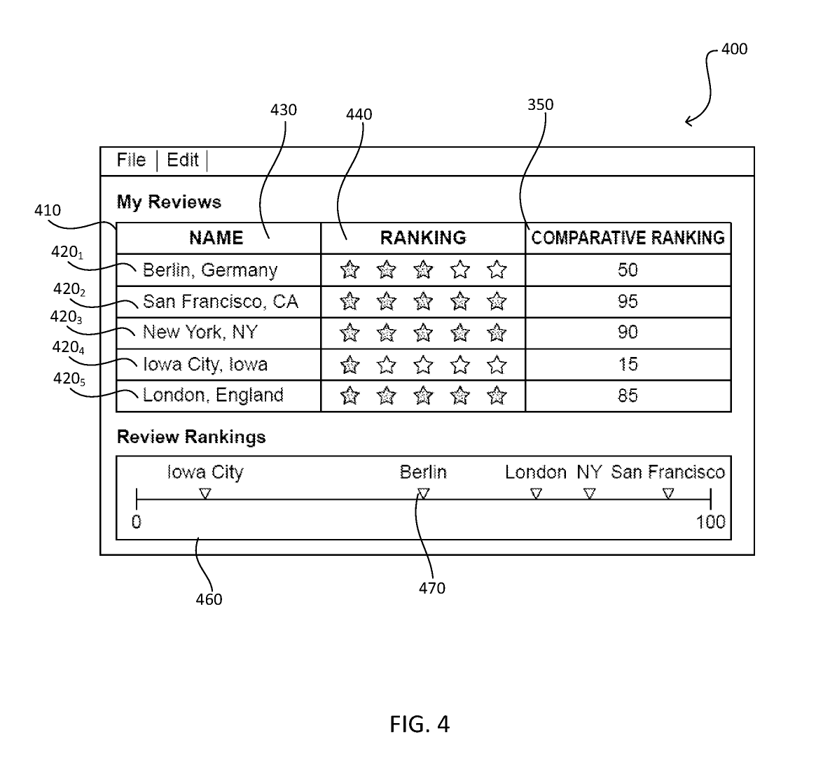

FIG. 4 illustrates an exemplary embodiment of a photo-review interface 400. The interface shows various ways of displaying multiple reviews 420₁, 420₂, . . . , 420₅ (collectively, “420”) created by a user. One embodiment shows all the reviews 420 in a list 410, where the list 410 is not ordered by ranking 440. Each review may have a name 430. As shown, a first ranking 440 may comprise only five symbols. For example, the user gave Berlin 3 out of 5 stars, San Francisco 5 out of 5 stars, New York 5 out of 5 stars, Iowa City 1 out of 5 stars, and London 5 out of 5 stars.

As addressed above, in some embodiments a user may, or must, provide a comparative ranking 350. A comparative ranking distinguishes two reviews with identical first rankings. Also, a comparative ranking can be used to rank one review with respect to a second review. In some embodiments, a user may be prompted to provide a comparative ranking in response to two reviews receiving the same first ranking. In this example, San Francisco 420₂ was given a comparative ranking of 95, New York 420₃ received a 90, and London 420₅ received an 85. In some embodiments a list may be sorted by the comparative rankings.

Photo-review interface 400 also shows a widget for comparing reviews 460. As shown, the widget comprises a line and icons representing one or more reviews 470. In some embodiments, a user may slide icons one direction or another along a line in order to provide comparative rankings. In some embodiments, each section of the line represents a comparative ranking. For example, widget 460 indicates that San Francisco has a comparative ranking that is higher than New York's comparative ranking. Similarly, New York's comparative ranking is higher than London's comparative ranking.

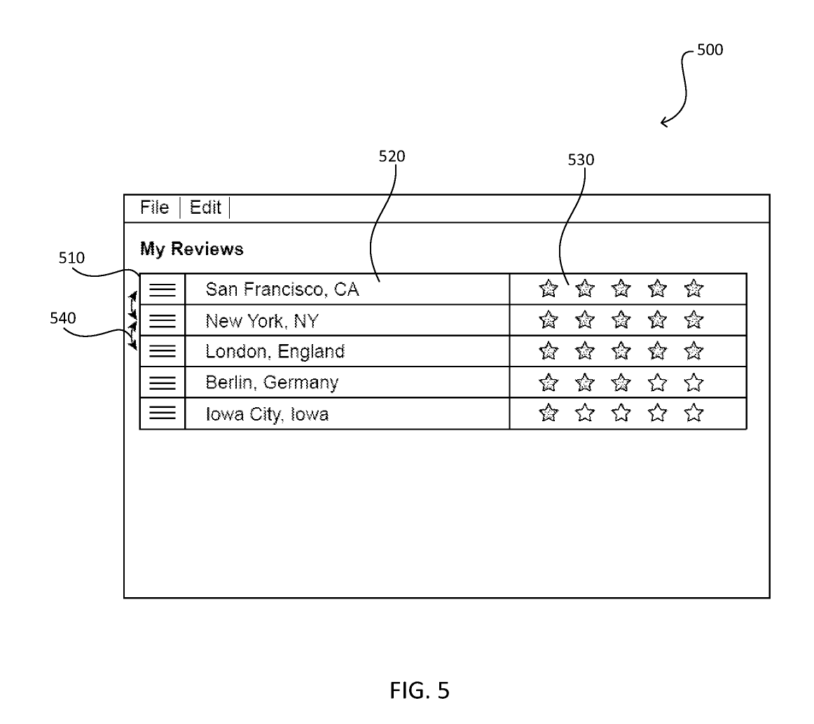

FIG. 5 illustrates an interface 500 that allows a user to rank reviews. This interface 500 shows a list of reviews 510 created by a user. In this case, the list is ordered by ranking 530. In this example, if a user wishes to place one review above another, they may simply drag the review 540 above another. In some embodiments, every time a user creates a new review, the user is prompted to compare the review with other previously created reviews. In such a case, the comparative ranking of that review is based on the position of the review on the list 510.

In some embodiments, the list 510 will not allow a user to move a review with a particular ranking 530 above a review with another ranking 530. For example, a user may not be able to drag Berlin above London because Berlin was given a three star ranking and London was given a five star ranking.

In some embodiments, a user's rating 550 may be shown on a page associated with a user and the reviews created by that user. This may allow someone looking at the review to distinguish what type of user created the rankings.

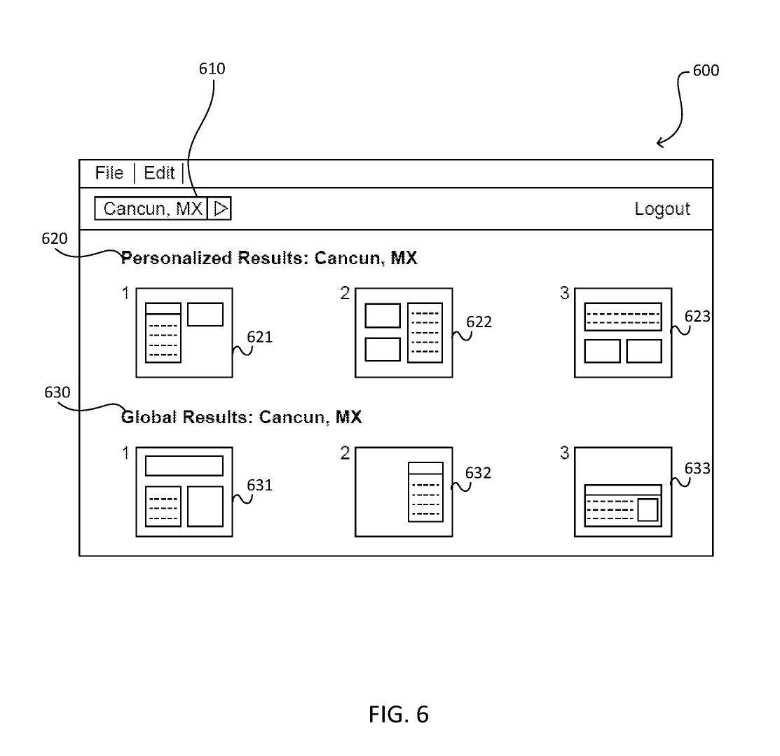

FIG. 6 illustrates an exemplary embodiment of a photo-review interface that allows a user to view photo-reviews. In some embodiments, personalized results 620 may be displayed. Personalized results 620 may include reviews 621, 622, 623 from users that give similar items similar rankings. In various embodiments a recommendation engine may be configured to provide personalized results. In some embodiments global results 630 are displayed. Global results 630 may include reviews 631, 632, 633 that are not based on previous reviews by a user. Further, global results may include reviews created by different types of users. For example, a user may search for reviews related to Cancun, Mexico by typing Cancun, MX into a search field 610. The review system 120 may then display a set of personalized results and/or global results. In some embodiments, a user may further customize their search. For example, a user may set parameters such that only reviews from a specified time period are shown. As another example, a user may set parameters such that only reviews created by users of a particular type are shown. In some embodiments, review system 120 is configured to display reviews created by friends or connections on social networking sites.

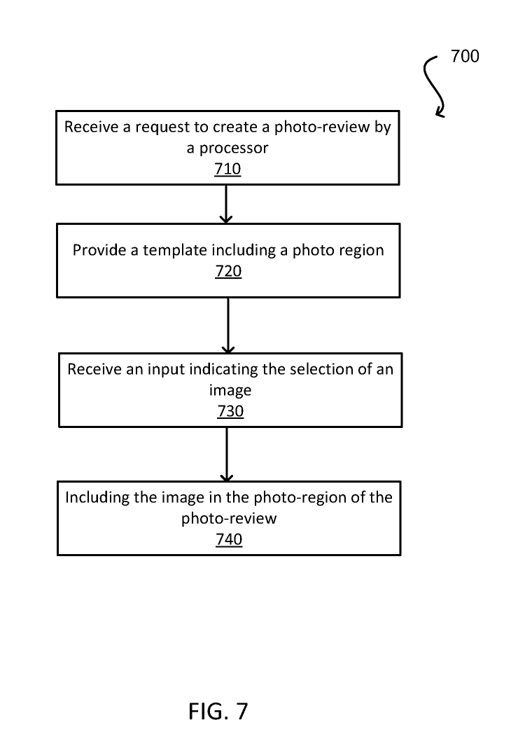

FIG. 7 illustrates an exemplary method embodiment of creating a photo-review. As shown, the method begins at block 710 where a request to create a photo-review is received by the review system 120. The review system can present one or more templates from the template database 720. In some embodiments, the system will provide a template based on the type of item to be reviewed.

The template includes a region for including a visual representation associated with the item to be reviewed, for example a photo region. The photo-region requires the input of an image of a particular size. In some embodiments, an image may be cropped as described above to become the required size. In some embodiments the size that the image must be is determined based on the size of the photo-region. In some embodiments, the method cannot continue unless a visual representation has been selected.

The method then continues to block 730 where an input indicating the selection of an image is received. Upon receiving the input, the method continues to block 740 where the image is included in the photo-region of the photo-review.

The template can additionally include regions to provide text and rankings. The template can also provide options to post the review to various social media sources, or to include links to social media platforms on the review.

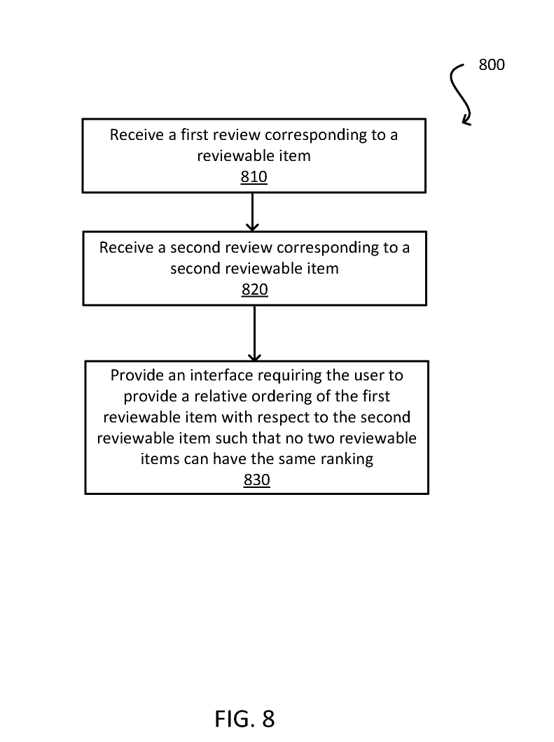

FIG. 8 illustrates an exemplary method embodiment of creating a photo-review. As shown, the method begins at block 810 where a first review corresponding to a reviewable item is received. The user that creates the first review provides a first ranking. At block 820, a second review by the same user corresponding to a second reviewable item is received. A second ranking is also received with the second review. For example, the first review could be a five star review of New York, and the second review could be a five star review of San Francisco.

Upon receiving the first review and the second review, the two having the same ranking, at step 830 an interface is provided requiring the user to provide a relative ordering of the first reviewable item such that no two reviewable items can have the same ranking. The method then ends.

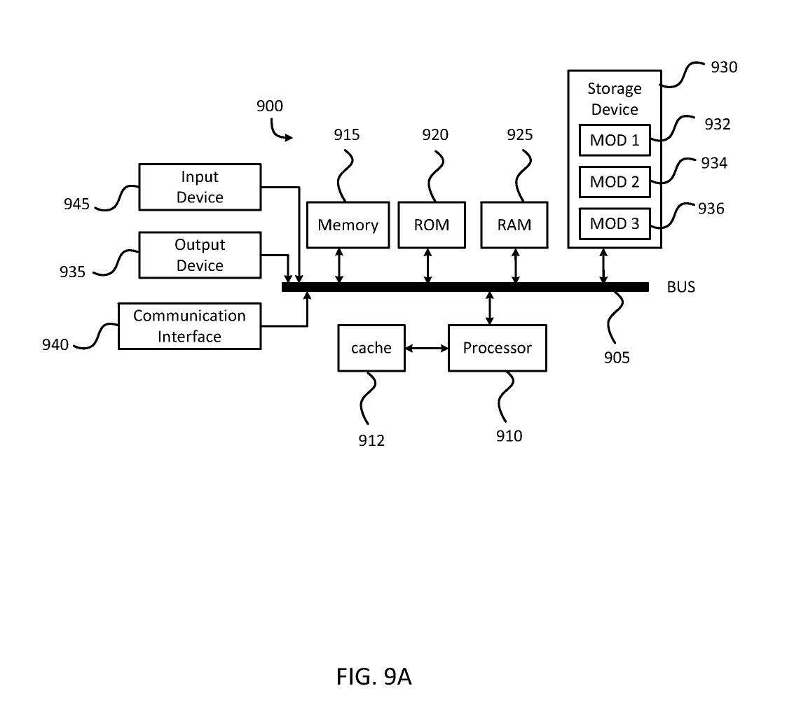

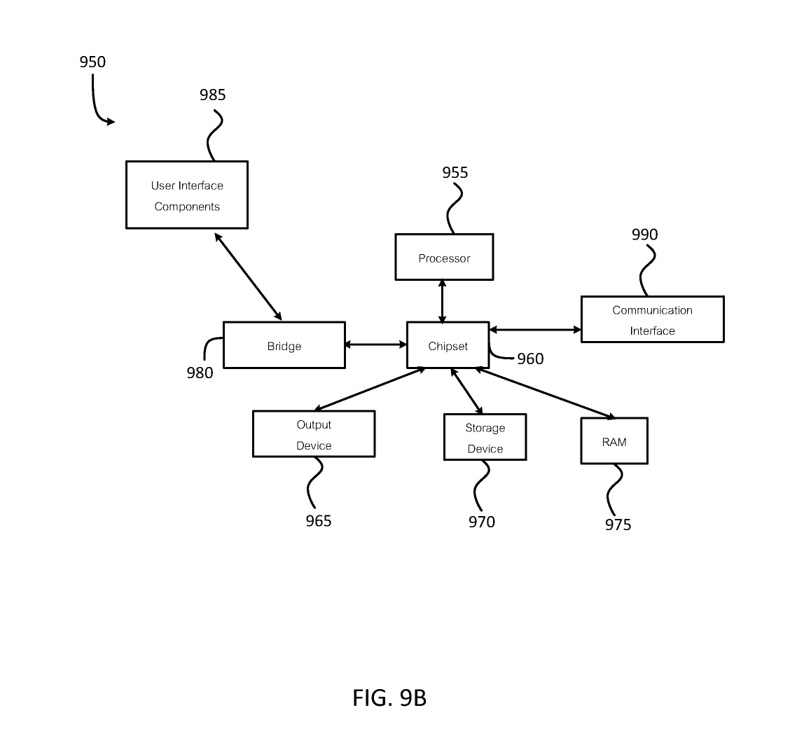

FIG. 9A, and FIG. 9B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a processor, a request to create a photo-review of an item;
providing a template including a photo region, the photo-region requiring an input of an image;
receiving an input indicating the selection of an image;
upon receiving an input indicating selection of an image, including the image in the photo-region of the photo-review;
receiving an input indicating a ranking for the item.

2. The method of claim 1, further comprising:
receiving an input causing the selected image to be cropped such that the selected image is the particular size.

3. The method of claim 1, further comprising:
receiving an input causing the selected image to be positioned within the photo-region such that portions of the selected image outside of the photo-region are not visible.

4. The method of claim 1, wherein the type or amount of text is based on the template.

5. The method of claim 1, wherein the text is placed in a location within the photo-review based on the template.

6. The method of claim 1, wherein the theme of the review is based on the template.

7. The method of claim 1, wherein the arrangement of text and images is based on the template.

8. A computer-readable medium storing computer executable instructions for causing a computer to perform the method comprising:
receiving a first review corresponding to a first reviewable item, the first review created by a first user, the first review including a first ranking;
receiving a second review corresponding to a second reviewable item, the second review created by the first user, the second review including a second ranking, the first ranking and second ranking being the same; and
providing an interface requiring the user to provide a relative ordering of the first reviewable item with respect to the second reviewable item such that no two reviewable items have the same ranking.

9. The computer-readable medium of claim 8, wherein the method further comprises:
adjusting the relative ordering based a rating associated with the user, the rating based on previous reviews by the user.

10. The computer-readable medium of claim 8, wherein the method further comprises:
creating a first list of reviewable items ordered by their respective rankings, the first list corresponding to the first user.

11. The computer-readable medium of claim 10, wherein the method further comprises:
creating a combined list of reviewable items based at least in part on the first list and a second list of reviewable items ordered by their respective rankings, the second list created by a second user.

12. The computer-readable medium of claim 10, wherein the first list of rankings is configured to be modified by a second user.

13. The computer-readable medium of claim 8, wherein each review is a photo-review.

14. The computer-readable medium of claim 8, wherein the method further comprises:
adjusting the first ranking or the second ranking based at least in part on a popularity of the reviewable items, wherein the popularity is measured by the amount of activity associated with a reviewable item on one or more social networking websites.

15. The computer-readable medium of claim 8, wherein the reviewable items are geographic locations.

16. A computing system, comprising:
one or more processors; and
a memory device including instructions that, when executed by the one or more processors, cause the computing system to:
receive a first review corresponding to a first reviewable item, the first review created by a first user, the first review corresponding to a first ranking;
receive a second review corresponding to a second reviewable item, the second review created by the first user, the second review corresponding to a second ranking;
provide an interface requiring the first user to provide a first relative ordering of the first reviewable item with respect to the second reviewable item, wherein the first reviewable item and the second reviewable item have the same ranking; and
generate a first ordered list of reviewable items based on the first relative ordering.

17. The computing system of claim 16, wherein the one or more processors further cause the computing system to:
receive a third review corresponding to the first reviewable item, the third review created by a second user, the third review having a third ranking;
receive a fourth review corresponding to the second reviewable item, the fourth review created by a second user, the fourth review having a fourth ranking; and
provide an interface requiring the second user to provide a second relative ordering of the first reviewable item with respect to the second reviewable item, the third reviewable item, and the fourth reviewable item.

18. The computing system of claim 17, wherein the one or more processors further cause the computing system to:
generate a second ordered list of reviewable items based on the first relative ordering and the second relative ordering.

19. The computing system of claim 18, wherein the second ordered list is generated based on a first user-rating corresponding to the first user and a second user-rating corresponding to a second user, the first user-rating based on previous reviews by the first user, the second-rating based on previous reviews by the second user.

20. The computing system of claim 16, wherein the one or more processors further cause the computing system to:
adjusting the first ordered list of reviewable items based at least in part on a popularity of the geographic locations associated with the reviewable items, wherein the popularity is measured by the amount of activity associated with a geographic location on one or more social networking websites.

21. The computing system of claim 16, first ordered list of reviewable items is configured to be modified by a second user.
